(19) United States
(12) Patent Application Publication
(10) Pub. No.: US 2011/0016455 A1
(43) Pub. Date: Jan. 20, 2011

(54) Power Profiling for Embedded System Design

(76) Inventors: Glenn Perry, Mobile, AL (US); Herbert Yuen, Mobile, AL (US); Manfred Kreutzer, Vienna (AT); Thomas Gatterweh, Vienna (AT)

Correspondence Address: MENTOR GRAPHICS CORP.;PATENT GROUP, 8005 SW BOECKMAN ROAD, WILSONVILLE, OR, 97070-7777, US

(21) Appl. No.: 12/697,291

(22) Filed: Jan. 31, 2010

Related U.S. Application Data
(60) Provisional application No. 61/226,951, filed on Jul. 20, 2009.

(51) Int. Cl. G06F 9/44

(52) U.S. Cl. 717/130; 717/124

(57) ABSTRACT

The power usage of software executable by an embedded system may be profiled without the need for test benches or power measurement systems. Additionally, the power profiles corresponding to multiple pieces of software may be determined and compared.

### RELATED APPLICATIONS

This application claims priority under 35 U.S.C. §119(e) to U.S. Provisional Patent Application No. 61/226,951 entitled “Power Profiling For Embedded System Design,” filed on Jul. 20, 2009, and naming Herbert Yuen et al. as inventors, which application is incorporated entirely herein by reference.

### FIELD OF THE INVENTION

The invention relates to the design of embedded electronic systems. More specifically, various implementations of the invention are applicable to analyzing the power requirements of an embedded system.

### BACKGROUND OF THE INVENTION

In general, an embedded system may be described as a special purpose computing system designed to perform one or a few dedicated functions. Embedded systems are commonly used in consumer devices like personal digital assistants, mobile phones, videogame consoles, microwaves, washing machines, alarm systems, and digital cameras. In addition to the consumer space, embedded systems are used in nearly every industry, from telecommunications to manufacturing, and from transportation to medical devices. In fact, embedded systems are so commonly in use today that it is not feasible to exhaustively list specific examples.

The term “embedded system” does not have a precise definition, and determining what is and is not an embedded system can be difficult. For example, a general purpose computer, such as a laptop, is not typically characterized as an embedded system. However, a laptop is usually composed of a multitude of subsystems such as the hard disk drive, the motherboard, the optical drive, the video processing unit, and various communication devices. Many of the individual subsystems comprising the laptop may themselves be embedded systems.

The complexity of embedded systems can vary from, for example, systems with a single microcontroller chip and a light emitting diode to systems with multiple microprocessor units and various peripheral communication interfaces and mechanical parts. Manufacturers of modern microprocessors are increasingly adding components and peripheral modules to their microprocessors, creating what may be thought of as embedded processors. This type of embedded system is often referred to as a system on a chip (SoC). A simple example of a system on chip is an application-specific integrated circuit (ASIC) packaged with a universal serial bus (USB) port. Additionally, embedded systems range from those having no user interface at all to those with full user interfaces similar to a desktop operating system.

There are many advantages to using embedded systems. For example, an embedded system typically is designed to do some specific task, as opposed to being a general purpose computer with a wide range of features for performing many different tasks. As a result, design engineers can optimize the embedded system for the desired task, which assists in reducing the size and cost of the device as well as increasing its reliability and performance. Furthermore, functionalities can be designed into an embedded system that would not be feasible using hardware alone.

By using software to accomplish some of the functionality that would have been accomplished in hardware, designers may specify and define certain functionality later in the design cycle than was previously possible. An additional advantage is that embedded system designs can often be reconfigured for different functionality with less engineering overhead than a design embodied entirely by hardware. As a result, design reuse can be increased, resulting in a reduced time to market.

The software written for embedded systems is generally referred to as “firmware.” Firmware is often stored on read only memory (“ROM”) based storage devices. For example, flash-based read only memory or electronically erasable read only memory (“EEPROM”) devices are often used to store firmware. The firmware controls the various features, functioning, and interfaces of the embedded system. Thus, a digital video disk player will have firmware that processes the appropriate response to an input, such as the user pressing the “power” button or the “play” button. Additionally, the firmware in this example would control the storage mechanism, the digital processing circuitry used to decode and output onto the appropriate ports the video and audio signals stored on the video storage medium, as well as the user interface allowing the user to configure settings of the digital video disk player.

Modern embedded systems often allow the user to execute an additional application, often referred to as an “app”, on the device. For example, an app may be loaded into a memory location accessible by the embedded systems firmware such that the app may be executed by the embedded systems firmware. The various instructions that the embedded system executes, such as, for example, the firmware or apps, are often referred to herein as “computer executable applications”. However, they may also be referred to herein as firmware, software, applications, programs, or apps.

Power consumption is typically of concern to the designers of an embedded system. Furthermore, power consumption is increasingly becoming important to users of embedded systems. For example, one reason that the power consumption of an embedded system powered from a rechargeable battery may be of concern is that the power consumption dictates how long it can be used without recharging the battery. Additionally, power consumption of embedded systems may be of concern for financial or environmental reasons. As stated previously, an embedded system includes applications and hardware. Applications, like hardware, have an effect upon the amount of power consumed by a particular embedded system.

### BRIEF SUMMARY OF THE INVENTION

Various embodiments of the invention provide methods and related apparatus for estimating or “profiling” the amount of power consumed by software executed on an embedded system. In some implementations, the power consumption is estimated by first identifying software, which is executable by the embedded system, and subsequently traversing the software to determine or derive a power consumption profile. With some implementations, traversing the software determines a set of power consumption metrics. These power consumption metrics may be used to determine the amount of power consumed during execution of the software, without the need to actually execute the software and measure the power consumption.

With further implementations, a power consumption profile for two or more pieces of software may be generated, and if desired, compared.

These and other features and aspects of the invention will be apparent upon consideration of the following detailed description of illustrative embodiments.

### BRIEF DESCRIPTION OF THE DRAWINGS

The present invention will be described by way of illustrative embodiments shown in the accompanying drawings in which like references denote similar elements, and in which:

FIG. 1 illustrates an example of an embedded system;

FIG. 2 illustrates an embedded system simulation environment;

FIG. 3 illustrates an embedded system testing environment;

FIG. 4 shows an illustrative operating environment;

FIG. 5 illustrates a method of generating a power consumption profile according to various implementations of the present invention; and

FIG. 6 illustrates a method of traversing an application according to various implementations of the present invention.

### DETAILED DESCRIPTION OF ILLUSTRATIVE IMPLEMENTATIONS

As stated above, various implementations of the invention provide method and related apparatus to generate a power consumption profile for an embedded system. This power consumption profile may then be used to determine the power consumption, or the power requirements of software that may be executed by the embedded system. As such, brief overviews of embedded systems, as well as an illustrative operating environment suitable for practicing the invention are described.

### Overview of an Illustrative Embedded System

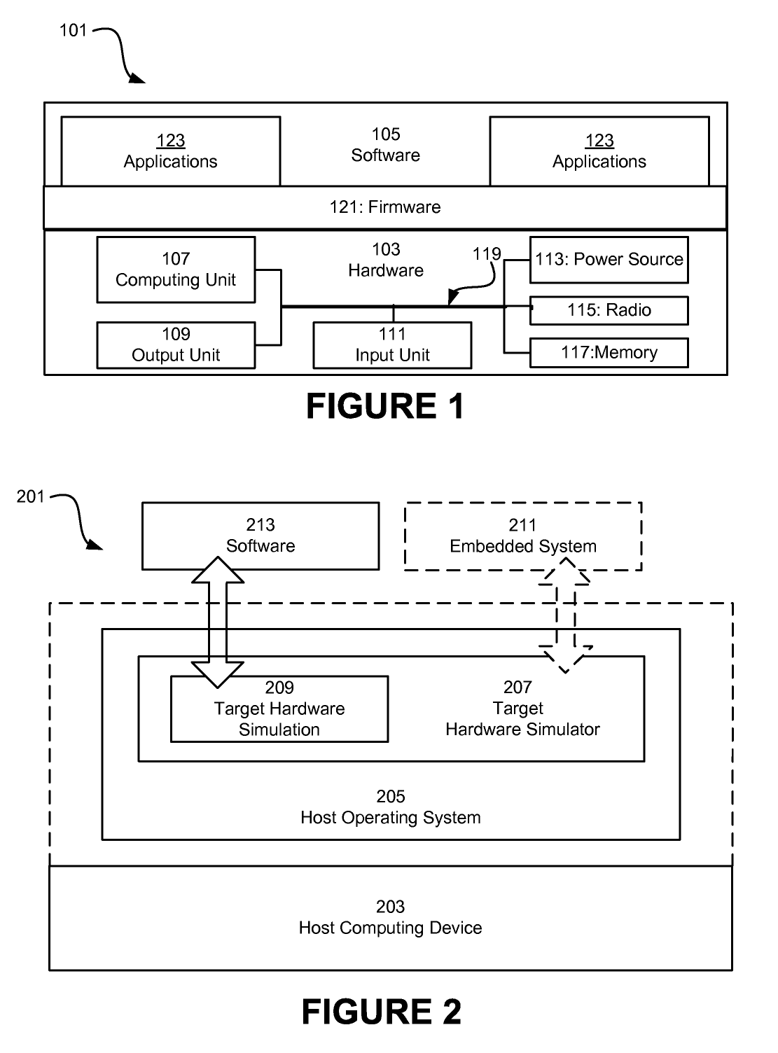

As detailed above, an embedded system is a combination of hardware and software, often designed for a particular task. FIG. 1 illustrates an embedded system 101. As can be seen from this figure, the embedded system 101 includes a hardware component 103 and a software component 105. As illustrated, the hardware component 103 includes a computing unit 107, an output unit 109, an input unit 111, a power source 113, a radio 115, and a memory 117. The hardware components are interconnected with a bus 119. Those of skill in the art will appreciate that not all embedded systems include the features illustrated in FIG. 1.

The software component 105 includes a firmware 121, and may additionally include software applications 123. As those of skill in the art can appreciate, the firmware 121 typically includes the drivers necessary for the functioning of the hardware 103. The firmware 121 may often provide for various features and functionality of the hardware 103. In addition to the firmware 121, applications 123 may provide supplemental or additional features to the firmware 121. The methods detailed herein are equally applicable to the measurement and prediction of power consumption of all types of software, (e.g, firmware and applications.) As used herein, software may refer to both firmware and applications. Additionally, if reference is made to applications, firmware may be included in the reference.

During embedded system design development, it is often desirable to test software prior to the availability of a prototype of the embedded system hardware. Accordingly, a simulation environment, often referred to as a host simulation environment, may be provided. Host simulation is the process of simulating a hardware device using software, and employing the hardware device simulation to test an application designed to run on the hardware device. The hardware device is often referred to as the embedded system or the “target.”

FIG. 2 illustrates a host simulation environment 201. As can be seen from this figure, the host simulation environment 201 includes a host computing device 203 and a host operating system 205, running on the host computing device 203. A target hardware simulator 207 may be run on the host operating system 205. As illustrated, the target hardware simulator 207 is capable of instantiating a target hardware simulation 209. The target hardware simulation 209 is a simulation of an embedded system 211. With various implementations of the invention, the target hardware simulator 207 may be an independent program executed upon the host operating system 205. With still other implementations of the invention, however, the target hardware simulator 207 may be an independent program executed upon a second computing device, which communicates with the host computing device 203 and the host operating system 205. The host operating system 205 is further capable of executing or debugging software 213. As can be seen in FIG. 2, the software 213 interacts with the host operating system 205, the target hardware simulator 207 and the target hardware simulation 209.

As stated above, the target hardware simulator 207 is capable of instantiating the target hardware simulation 209 as a simulated version of the embedded system 211. In various implementations of the invention, the embedded system 211 is in design form. More particularly, the embedded system 211 may be described by a design document, such as, for example, a Verilog design file. As those of skill in the art can appreciate, the design document details the functioning and/or architecture of the embedded system 211. Various functional description languages exist, such as, for example, the very high speed integrated circuit hardware description language (VHDL,) which may be employed to describe the embedded system 211. Additionally, functional configurations may be specified, such as the memory configuration and the input and output configuration.

The software 213 can be a simple program for performing the function specified for the embedded system 211. For example, the embedded system 211 may be a simple spark timing controller for an automobile, with the software 213 then being the software program that computes the appropriate spark timing based upon specified parameters. The software 213 also may be a complex software program, including both device driver code that interacts with the hardware of the embedded system 211, and user interface code that specifies how a user may interact with the hardware of the embedded system 211. For example, the software 213 may be a real time operating system (RTOS), such as the Nucleus™ operating system available from Mentor Graphics Corporation of Wilsonville, Oreg., or the Android™ operating system available from Google™ of Mountain View, Calif.

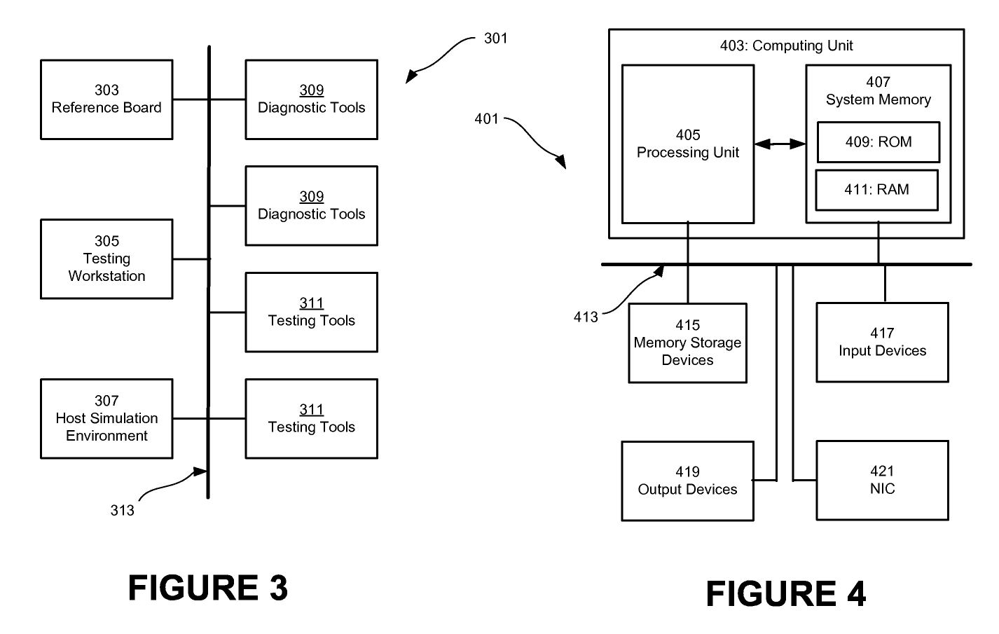

It is also often desirable to perform tests for an embedded system once a prototype is available. Often, devices referred to as “reference boards,” which have the functionality of the embedded system but still provide an interface to interact with diagnostic and testing tools, are employed during the design and testing of an embedded system. FIG. 3 illustrates a testing environment 301. As can be seen from this figure, the testing environment 301 includes a reference board 303, a testing workstation 305, and a host simulation environment 307. Additionally, the testing environment 301 includes diagnostic tools 309 and testing tools 311. As illustrated, the various components of the testing environment, such as, the reference board, are interconnected by a bus 313.

### Illustrative Operating Environment

As stated, various examples of the invention may be implemented through the execution of software instructions by a computing device (e.g, the host computing device 203 of FIG. 2.) Accordingly, FIG. 4 shows an illustrative example of a computing device 401. As seen in this figure, the computing device 401 includes a computing unit 403 with a processing unit 405 and a system memory 407. The processing unit 405 may be any type of programmable electronic device for executing software instructions, but will conventionally be a microprocessor. The system memory 407 may include both a read-only memory (ROM) 409 and a random access memory (RAM) 411. As will be appreciated by those of ordinary skill in the art, both the read-only memory 409 and the random access memory 411 may store software instructions for execution by the processing unit 405.

The processing unit 405 and the system memory 407 are connected, either directly or indirectly, through a bus 413 or alternate communication structure, to one or more peripheral devices. For example, the processing unit 405 or the system memory 407 may be directly or indirectly connected to one or more additional memory storage devices 415. The memory storage devices 415 may include, for example, a “hard” magnetic disk drive, a solid state disk drive, an optical disk drive, and a removable disk drive. The processing unit 405 and the system memory 407 also may be directly or indirectly connected to one or more input devices 417 and one or more output devices 419. The input devices 417 may include, for example, a keyboard, a pointing device (such as a mouse, touchpad, stylus, trackball, or joystick), a scanner, a camera, and a microphone. The output devices 419 may include, for example, a display device, a printer and speakers. With various examples of the computing device 401, one or more of the peripheral devices 415-419 may be internally housed with the computing unit 403. Alternately, one or more of the peripheral devices 415-419 may be external to the housing for the computing unit 403 and connected to the bus 413 through, for example, a Universal Serial Bus (USB) connection or a digital visual interface (DVI) connection.

With some implementations, the computing unit 403 may also be directly or indirectly connected to one or more network interfaces cards (NIC) 421, for communicating with other devices making up a network. The network interface cards 421 translate data and control signals from the computing unit 403 into network messages according to one or more communication protocols, such as the transmission control protocol (TCP) and the Internet protocol (IP). Also, the network interface cards 421 may employ any suitable connection agent (or combination of agents) for connecting to a network, including, for example, a wireless transceiver, a modem, or an Ethernet connection.

It should be appreciated that the computing device 401 is illustrated as an example only, and it not intended to be limiting. Various embodiments of the invention may be implemented using one or more computing devices that include the components of the computing device 401 illustrated in FIG. 4, which include only a subset of the components illustrated in FIG. 4, or which include an alternate combination of components, including components that are not shown in FIG. 4. For example, various embodiments of the invention may be implemented using a multi-processor computer, a plurality of single and/or multiprocessor computers arranged into a network, or some combination of both.

### Power Profile Generation

As stated above, various implementations of the invention provide methods and related apparatus to generate a power consumption profile corresponding to software executable by an embedded system. In various implementations, a power consumption profile may be generated for multiple pieces of software, and subsequently compared to determine the most efficient software (i.e., related to power usage.) In additional implementations, the power consumption profile may be employed to determine potential areas of improvement of the software, for example improvements that may increase the power efficiency of the software.

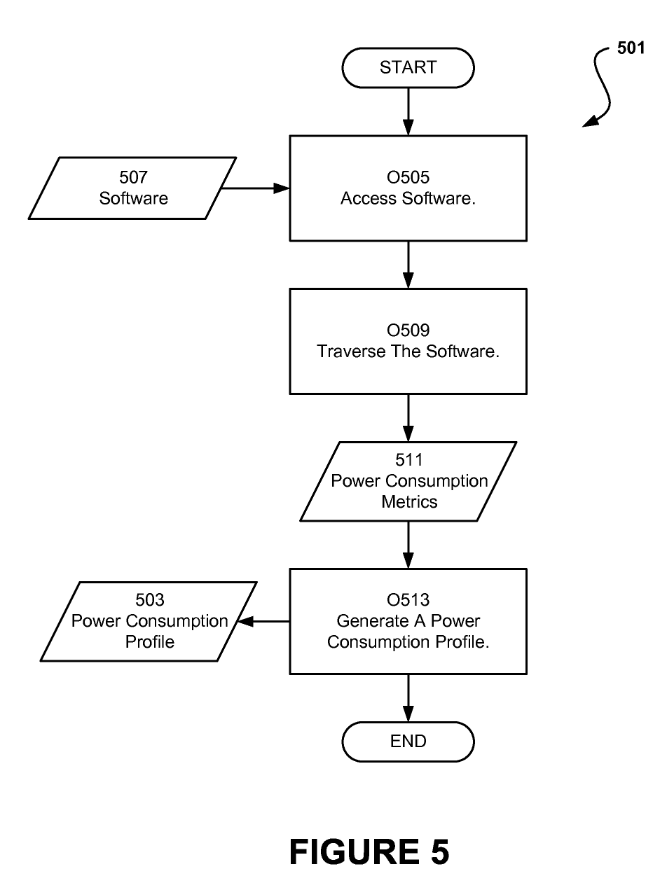

FIG. 5 illustrates a process 501 for generating a power consumption profile 503 corresponding to software 505 executable on and an embedded system (e.g., the software 105 of the embedded system 101 shown in FIG. 1.) As can be seen from FIG. 5, the process 501 includes an operation 507 for accessing the software 505. In various implementations, the operation 507 loads the software 505, which, for example, may have been identified by a user of the method 501, into a memory storage location, such as, for example, one or more of the memory storage devices 415 shown in FIG. 4.

The method 501 further includes an operation 509 for traversing the application 507, resulting in the generation of a set of power consumption metrics 511. Furthermore, the method 501 includes an operation 513 for generating the power consumption profile 503. As indicated above, the power consumption profile 503 may be an estimate of the amount of power that the application 507 will require to run.

### Generation of the Set of Power Consumption Metrics

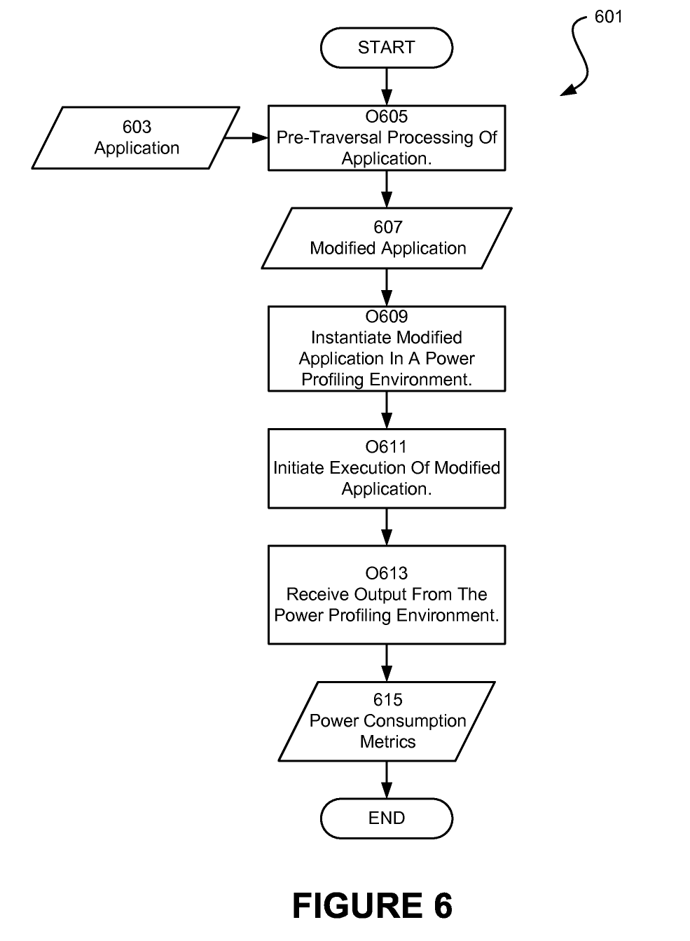

FIG. 6 illustrates a method 601, which may be employed in various implementations, to traverse an application 603. In various implementations, the operation 509 of FIG. 5 implements the method 601. As can be seen from FIG. 6, the method 601 includes an operation 605 for performing a pre-traversal processing of the application 603, resulting in a modified application 607. With various implementations of the invention, the operation 605 modifies the application 603 by inserting additional instructions into the application 603. In some implementations, the additional instructions provide for the extraction of information when the modified application 603 is executed.

The method 601 further includes an operation 609 for instantiating the modified application 607 in a power profiling environment (e.g., the testing environment 301 of FIG. 3 or the host simulation environment 201 of FIG. 2,) an operation 611 for initiating execution of the modified application 607 by the power profiling environment, and an operation 613 for receiving output from the power profiling environment during the execution, resulting in a set of power consumption metrics 615.

As stated, the operation 605 may insert additional instructions into the application 603. With some implementations, the additional instructions provide for the extraction of the number of instructions executed by the modified application 607. In various implementations, for example, the additional instructions provide for the extraction of the number of instructions and the type of instructions executed by the modified application 607. The extracted outputs, such as, for example, the number of executed instructions or the type of extracted instructions, form the set of power consumption metrics 615.

In various implementations, each time a function is entered during traversal of the application, power usage data associated with that function may be monitored. With further implementations, nested and recursive instruction calls within the function may be counted and recorded in the power consumption metrics 615. Upon exit of the function, the data associated with that particular function's execution may be merged into the running total of instructions recorded in the power consumption metrics 615. The following is illustrative of how a sample of code might be modified to record power consumption metrics:

| add | r12, r12, #3 | ; add to accumulative instruction count |
|---|---|---|
| ldr | r0, [sp, #8] | |
| cmp | r0, #10 | |
| blt | \|.2\| | |

As stated, in addition to determine the total number of instructions executed, the type of instruction, such as, for example, whether the instruction is a memory access instruction or not, may be recorded in the power consumption metrics 615. The following is illustrative of how a sample code might be modified to behave as such:

| | | |
|---|---|---|
| mov | r11, \|literal.0\| | ; put memory address in r11 |
| bl | _pp_mem_access | ; evaluate power usage for memory access |
| ldr | r1, \|literal.0\| | |
| mov | r11, r1 | ; put memory address in r11 |
| bl | _pp_mem_access | ; evaluate power usage for memory access |
| ldr | r2, [r1] | |
| add | r2, r2, #1 | |

In various implementations, each memory access will be modified (e.g., by the operation 605) such that power usage associated with the memory access instruction may be tracked. In various implementations, this is facilitated by passing the address of the memory location to a data collection function. With some implementations, instructions that access multiple memory locations (e.g. load or store data to multiple addresses) are tracked by passing a starting address and subsequently deriving the number of memory accesses by decoding the instruction to be executed. For example, the following code illustrates one method of doing this:

| | |
|---|---|
| mov | r11, sp ; put memory address in r11 |

bl _pp_mult_mem_access ; evaluate power usage for memory access
stmfd sp!, {r3-r5, lr}

### Generation of the Power Consumption Profile

Returning to FIG. 5, the method 501 includes the operation 513 for generating the power consumption profile 503 from the power consumption metrics 511. As can be appreciated by this point, the power consumption metrics detail the amount of “work” the embedded system does when executing the software 507. More particularly, the power consumption metrics include information not readily available from the software, such as for example how many instructions the processor (e.g., the computing unit 107) executed while running the software. Additionally, information such as if the instructions required accessing a memory location may be included in the power consumption metrics 615. This information is then used to determine an estimate for the amount of power required to execute the software 507. Although the power consumption metrics do no include an actual “amount” of power (e.g., in watts or amps) each instruction consumes, this information may be discernible to designers.

In various implementations, the above described methods are implemented on different software designed for the same embedded system. After which, the power consumption profile for the different software may be compared to determine which piece of software is the most efficient.

### Conclusion

Although certain devices and methods have been described above in terms of the illustrative embodiments, the person of ordinary skill in the art will recognize that other embodiments, examples, substitutions, modification and alterations are possible. It is intended that the following claims cover such other embodiments, examples, substitutions, modifications and alterations within the spirit and scope of the claims.

1. A computer-implemented method for generating a power profile for a computer executable application, the method comprising:
identifying a computer executable application;
traversing the computer executable application, the traversing generating a plurality of power consumption metrics;
generating a power profile for the computer executable application based in part upon the plurality of power consumption metrics; and
storing the power profile to a memory storage location.

2. The computer-implemented method recited in claim 1, the method further comprising displaying the power consumption profile for a user of the method.

3. A computer-implemented method for generating a power profile for a computer executable application, the method comprising:
identifying a computer executable application;
identifying a power specification corresponding to the computer executable application;
causing the computer executable application to be executed;
recording a plurality of power consumption metrics based in part upon the execution of the computer executable application;
generating a power profile for the computer executable application based in part upon the plurality of power consumption metrics and the power specification; and
storing the power profile to a memory storage location.

4. The computer-implemented method recited in claim 3, the method further comprising:
inserting one or more power profiling operations into the computer executable application; and wherein
the method act for causing the computer executable application to be executed additionally causes the one or more power profiling operations to be executed.

5. The computer-implemented method recited in claim 4, wherein the method act of causing the computer executable application to be executed comprises:
identifying an embedded system environment;
causing the computer executable application to be executed by the embedded system environment;
causing the one or more power profiling operations to be executed by the embedded system environment, the one or more power profiling operations generating one or more power consumption metrics; and
identifying the one or more power consumption metrics.

6. The method recited in claim 5, wherein:
the method act of causing the computer executable application to be executed causes a plurality of instructions to be invoked;
a one of the one or more power profiling operations comprises counting the number of times the plurality of instructions are invoked; and
a one of the plurality of power consumption metrics is the number of time the plurality of instructions are invoked.

7. The method recited in claim 6, wherein:
the computer executable application includes a plurality of functions, each function causing one or more of the plurality of instructions to be invoked;
a one of the one or more power profiling operations comprises counting the number instructions invoked each time a one of the plurality of functions is invoked; and
a one of the plurality of power consumption metrics is the number instructions invoked each time the functions are called.

8. The method recited in claim 7, wherein:
ones of the plurality of instructions are memory access instructions;
for the ones of the plurality of instructions that are memory access instructions, determining the type of memory access instruction;
a one of the one or more power profiling operations comprises counting the number of times each type of memory access instruction is invoked; and
a one of the plurality of power consumption metrics is the number of time the ones of the plurality of instructions that are memory access instructions are invoked.

9. The method recited in claim 7, the method act of generating a power profile for the computer executable application comprising:
for each one of the plurality of power consumption metrics, identifying a corresponding unit of power consumed based upon the specification; and
deriving an amount of power consumed for the computer executable application based in part upon the plurality of power consumption metrics and the unit of power consumed.

10. A computer program product for generating a power profile for a computer executable application comprising:
software instructions for enabling a computer to perform a set of operations; and
one or more tangible computer-readable media bearing the software instructions;
the set of operations including:
identifying a computer executable application;
identifying a power specification corresponding to the computer executable application;
traversing the computer executable application, the traversing generating in a plurality of power consumption metrics;
generating a power profile for the computer executable application based in part upon the plurality of power consumption metrics and the power specification; and
storing the power profile to a memory storage location.

11. The computer program product recited in claim 10, the operation for traversing the computer executable application comprises causing the computer executable application to be executed.

12. The computer program product recited in claim 11, the set of operations further comprising:
inserting one or more power profiling operations into the computer executable application; and wherein
the operation for traversing the computer executable application additionally traverses the one or more power profiling operations.

13. The computer program product in claim 12, the operation for causing the computer executable application to be executed comprises:
identifying an embedded system environment;
making the computer executable application available to the embedded system environment;
causing the embedded system environment to execute the computer executable application including the one or more power profiling operations, the execution of the one or more power profiling operations outputting one or more power consumption metrics; and
identifying the one or more power consumption metrics.

14. The computer program product recited in claim 13, wherein:
the computer executable application includes a plurality of instructions;
the method act of causing the embedded system environment to execute the computer executable application results in the plurality of instructions to being invoked;
a one of the one or more power profiling operations comprises counting the number of times the plurality of instructions are invoked; and
a one of the plurality of power consumption metrics is the number of time the plurality of instructions are invoked.

15. The computer program product recited in claim 14, wherein:
the computer executable application further includes a plurality of functions, each function including ones of the plurality of instructions;
a one of the one or more power profiling operations comprises counting the number of instructions invoked each time the plurality of functions are invoked; and
a one of the plurality of power consumption metrics is the number instructions invoked each time the plurality of functions are invoked.

16. The computer program product recited in claim 15, wherein:
ones of the plurality of instructions are memory access instructions;
for the ones of the plurality of instructions that are memory access instructions, determining the type of memory access instruction;
a one of the one or more power profiling operations comprises counting the number of times each type of memory access instruction is invoked; and
a one of the plurality of power consumption metrics is the number of time the ones of the plurality of instructions that are memory access instructions are invoked.

17. The computer program product recited in claim 16, wherein:
the power specification defines an amount of power consumed corresponding to each of the plurality of power consumption metrics; and
the operation for generating a power profile for the computer executable application comprises:
deriving an amount of power consumed for each for each one of the plurality of power consumption metrics, identifying a corresponding unit of power consumed based upon the specification; and
deriving an amount of power consumed for the computer executable application based in part upon the plurality of power consumption metrics and the unit of power consumed.

18. The computer program product recited in claim 14, wherein:
ones of the plurality of instructions are memory access instructions;
a one of the one or more power profiling operations comprises counting the number of times the ones of the plurality of instructions that are memory access instructions are invoked; and
a one of the power consumption metrics is the number of time the ones of the plurality of instructions that are memory access instructions are invoked.
